(19) United States
(12) Patent Application Publication
(10) Pub. No.: US 2024/0384716 A1
(43) Pub. Date: Nov. 21, 2024

(54) COMPRESSOR CYLINDER LUBRICATION SYSTEMS AND METHODS UTILIZING THREE-WAY VALVES

(71) Applicant: Chevron Phillips Chemical Company LP, The Woodlands, TX (US)

(72) Inventor: Preston A. Magee, Baytown, TX (US)

(21) Appl. No.: 18/317,149

(22) Filed: May 15, 2023

(51) Int. Cl. F04B 53/18; F04B 23/06; F04B 53/10

(52) U.S. Cl. CPC F04B 53/18; F04B 23/06; F04B 53/10

(57) ABSTRACT

The lubrication system for a compressor cylinder has three or more pumps, a three-way valve for each pump, and an oil collection pan. The pumps provide lubricating oil to the compressor cylinder. The three-way valve comprises one inlet for lubricating oil and two outlets. The first outlet is configured to direct lubricating oil to the compressor cylinder, and the second outlet is an atmospheric release to an oil collection pan. When maintenance is performed on a pump, the first outlet in the three-way valve is closed and the second outlet is opened. The compressor cylinder remains operational while maintenance is performed, eliminating downtime and allowing uninterrupted production. Once maintenance is complete, the first outlet is opened and the second outlet is closed, and the system returns to normal operation.

### FIELD OF THE DISCLOSURE

The present disclosure generally relates to a lubrication system for a compressor cylinder that utilizes a three-way valve and a method of operating the three-way valve and associated lubricating pumps when maintenance is required.

### BACKGROUND

Compressor cylinders are essential components of a compressor system, which increases pressure in different chemical processes. A compressor cylinder works by using a piston to compress materials; these pistons generate heat due to friction and require lubrication systems to reduce energy consumption and to function smoothly and efficiently. Often, these lubrication systems typically comprise a pump for circulating lubricating oil throughout the compressor cylinder. Specifically related to this present disclosure, the compressor produces high pressure ethylene for a polymerization reactor. When maintenance is required on a pump in the lubrication system, the polymerization reactor must be shut down and all reactants must be removed from the compressor. Shutdown of the process can take from six to eight hours, or more, for maintenance or replacement of a pump. It would be beneficial to decrease or eliminate shutdown time or provide an alternative to current methods of performing maintenance. Accordingly, it is to this end that the present disclosure is generally directed.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

A system for lubricating compressor cylinders and for performing maintenance on lubricating oil pumps is provided in an aspect of this disclosure. This system can comprise i) a compressor cylinder having a lubricating oil inlet and an optional lubricating oil outlet, ii) three or more pumps for circulating a lubricating oil to the lubricating oil inlet of the compressor cylinder, iii) a three-way valve downstream of each pump, each valve having an inlet through which the lubricating oil is introduced, a first outlet configured to introduce the lubricating oil to the lubricating oil inlet of the compressor cylinder, and a second outlet configured to discharge the lubricating oil, and iv) an oil collection pan configured to capture the lubricating oil from the second outlet of the three-way valve, and optionally from the lubricating oil outlet of the compressor cylinder.

In another aspect, a maintenance and lubrication method is provided, and in this aspect, the method can comprise I) circulating a first lubricating oil from a first pump through a first three-way valve into a lubricating oil inlet of a compressor cylinder and optionally discharging the first lubricating oil from a lubricating oil outlet, wherein the first three-way valve has an inlet for receiving the first lubricating oil from the first pump, a first outlet for discharging the first lubricating oil to the lubricating oil inlet of the compressor cylinder, and a second outlet for discharging the first lubricating oil to a first oil collection pan, II) circulating lubricating oils from two or more additional pumps through respective three-way valves into respective lubricating oil inlets of the compressor cylinder and optionally discharging the lubricating oils from the lubricating oil outlet, wherein the three-way valves have respective inlets for receiving the lubricating oils from the two or more additional pumps, respective first outlets for discharging the lubricating oils to the respective lubricating oil inlets of the compressor cylinder, and respective second outlets for discharging the lubricating oils to respective oil collection pans, III) removing the first pump from service, IV) closing the first outlet of the first three-way valve and opening the second outlet, V) performing maintenance on the first pump, VI) restoring flow of the first lubricating oil from the first pump through the first three-way valve, and VII) opening the first outlet of the first three-way valve and closing the second outlet.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

The following figures form part of the present specification and are included to further demonstrate certain aspects of the present disclosure. The present disclosure may be better understood by reference to one or more of these figures in combination with the detailed description of specific embodiments presented herein.

FIG. 1. is a schematic flow diagram of a system for lubricating a compressor cylinder using a three-way valve and a pump consistent with an aspect of this disclosure.

FIG. 2. is a schematic flow diagram of a system for lubricating a compressor cylinder using three pumps with respective valves consistent with another aspect of this disclosure.

FIG. 3. is a flow chart of the steps of a pump maintenance and lubrication method consistent with another aspect of this disclosure.

While the aspects disclosed herein are susceptible to various modifications and alternative forms, only a few specific embodiments are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the systems or methods described herein are contemplated with or without explicit description of the particular combination. Additionally, unless explicitly recited otherwise, any aspect or feature disclosed herein can be combined to describe inventive systems or methods consistent with the present disclosure.

In this disclosure, while systems and methods are described in terms of “comprising” various components or steps, the systems and methods also can “consist essentially of” or “consist of” the various components or steps, unless stated otherwise. The terms “a,” “an,” and “the” are intended to include plural alternatives, e.g., at least one, unless otherwise specified.

Several types of ranges are disclosed in the present disclosure. When a range of any type is disclosed or claimed, the intent is to disclose or claim individually each possible number that such a range could reasonably encompass, including end points of the range as well as any sub-ranges and combinations of sub-ranges encompassed therein. For example, high pressure conditions can be in various ranges in aspects of this disclosure. By a disclosure that high pressure conditions can be in a range from 20,000 to 60,000 psig, the intent is to recite that the pressure can be any amount in the range and, for example, can include any range or combination of ranges from 20,000 to 60,000 psig, such as from 20,000 to 50,000 psig, from 30,000 to 60,000 psig, or from 40,000 to 50,000 psig, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the disclosure, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described disclosure.

### DETAILED DESCRIPTION

Current lubrication systems for high pressure compressors require shutdown and purging of the compressor and other unit operations, such as a reactor, when maintenance is required on a lubrication pump. Such lubricating systems result in decreased production time and unnecessary downtime. Further, performing maintenance on pumps in these lubricating systems involves extensive personnel safety requirements. An objective of this disclosure is to increase production time and personnel safety during maintenance by providing an alternative lubricating system for high pressure compressors.

Herein, systems for lubricating a compressor cylinder and methods of conducting maintenance using a three-way valve are described. The systems can comprise a compressor cylinder, three or more pumps, a three-way valve for each pump, and an oil collection pan. The pumps circulate either new or recycled lubricating oil throughout the system. A three-way valve is positioned on the discharge line of the pumps. The three-way valve functions to direct lubricating oil through its inlet to one of two outlets. The first outlet directs lubricating oil to the inlet of the compressor cylinder, while the second outlet is an atmospheric release to direct lubricating oil to an oil collection pan. During normal operation, the second outlet is closed, and the first outlet is open, thereby directing lubricating oil to the compressor cylinder.

When maintenance is required on a pump, the pump rate is decreased or the pump is shutdown, the first outlet is closed, and the second outlet is opened to direct lubricating oil to the oil collection pan. Maintenance to repair or replace the pump occurs while the compressor system remains functional, thus a shutdown of the compressor—or reactor system supplied by the compressor—is avoided. Once maintenance is complete, flow is re-established and the second outlet is closed and the first outlet is opened, thereby direct lubricating oil to the compressor cylinder. The lubricating system returns to normal operation.

### Compressor Lubrication Systems

The lubrication system comprises a compressor cylinder having a lubricating inlet and an optional lubricating outlet, three or more pumps for circulating lubricating oil, a three-way valve downstream of each pump, and an oil collection pan for capturing lubricating oil. The three-way valve downstream of each pump has an inlet that receives lubricating oil from the pump and has two outlets. The first outlet is configured to introduce the lubricating oil to the inlet of the compressor cylinder, and the second outlet is configured to discharge lubricating oil, typically to an oil collection pan during maintenance. In one aspect of the disclosure, the compressor cylinder consumes the lubricating oil and does not have a lubricating oil outlet. However, in another aspect of this disclosure, the compressor cylinder has a lubricating oil outlet directing lubricating oil from the compressor cylinder to the oil collection pan. If lubricating oil is being recycled from the oil collection pan, a filtration unit upstream of the three or more pumps can be used to remove impurities. The filtered lubricating oil can be re-introduced to one or more of the pumps to recycle the lubricating oil back into the system. The recycled oil can be combined with fresh or new lubricating oil in any suitable relative amount.

Any suitable pump type can be utilized in the lubrication system, such as gear, piston, positive displacement, reciprocating, plunger, rotary, lobe, screw, diaphragm, axial, mixed flow, or radial pumps, as well as combinations of two or more pump types. Herein, a pump encompasses any device that moves fluids by mechanical action. A non-limiting example of a particular pump type that be utilized in the disclosed systems and methods is a reciprocating positive displacement plunger pump.

The system can further comprise a compressor having two or more compressor cylinders. In an aspect of this disclosure, the compressor can comprise eight compressor cylinders, although not limited thereto. In an illustrative but not limiting example, the compressor can be configured to deliver high pressure ethylene to a polymerization reactor, such as a tubular low density polyethylene (LDPE) reactor or an autoclave LDPE reactor. Typical operating pressures are in the 20,000 to 60,000 psig range, therefore the three-way valve used in the system and the system itself (e.g., all components of the system) can be configured to operate under high pressure conditions in the 20,000 to 60,000 psig range, such as from 20,000 to 50,000 psig, from 30,000 to 60,000 psig, or from 40,000 to 50,000 psig, and the like.

The lubrication system is configured to operate for a brief period of time (e.g., from 10 min to 10 hr) without one pump of the three or more pumps. For instance, two pumps are operating, while one pump is undergoing maintenance. The one pump removed from service can undergo maintenance and/or replacement, while beneficially the compressor and compressor cylinder are still fully operational.

The system can further comprise flow valves on each lubricating oil stream upstream of the three or more pumps. A non-limiting and representative list of suitable flow values include ball valves, butterfly valves, check valves, globe valves, and gate valves. The flow valves function to control flow of lubricating oil to each respective pump.

The system can further comprise one or more monitoring devices for measuring lubricating oil flow rate, lubricating oil pressure, lubricating oil temperature, and the like, as well as any combination thereof. Additionally, the system can comprise a controller configured to adjust the lubricating oil flow rate, the volume per stroke, the pump power, or any combination thereof, based on measurements or data from the one or more monitoring devices.

Optionally, the system can also comprise a valve controller configured to, for any of the three or more pumps, close the first outlet of the three-way valve and open the second outlet to remove a pump from service (e.g., reduced flow of oil or no longer supplying oil to the compressor cylinder), and to open the first outlet of the three-way valve and close the second outlet to restore normal operation of the pump.

Lastly, the system can further comprise any suitable injection device at the lubricating oil inlet of the compressor cylinder to inject lubricating oil into the compressor cylinder. A non-limiting example of a suitable injection device is an injection quill.

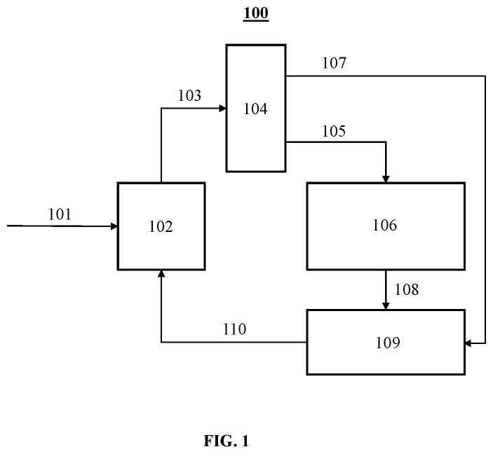

FIG. 1 is a flow diagram for a single pump and valve system 100 and illustrates the flow of lubricating oil throughout the system. New lubricant oil 101 is introduced to a pump 102. The pump 102 can also receive collected or recycled oil 110 from an oil collection pan 109 in aspects of the disclosure. The pump 102 produces a lubricant oil stream 103, which is connected to an inlet of a three-way valve 104. The three-way valve 104 directs lubricating oil through a first outlet to form a compressor oil stream 105, which is introduced into a compressor cylinder 106. While not required, lubricating oil can exit the compressor cylinder outlet as used lubricating oil 108, which is recovered in the collection pan 109. During maintenance, the first outlet of the three-way valve 104 is closed and a second outlet is opened directing oil through an atmospheric release stream 107 to the oil collection pan 109.

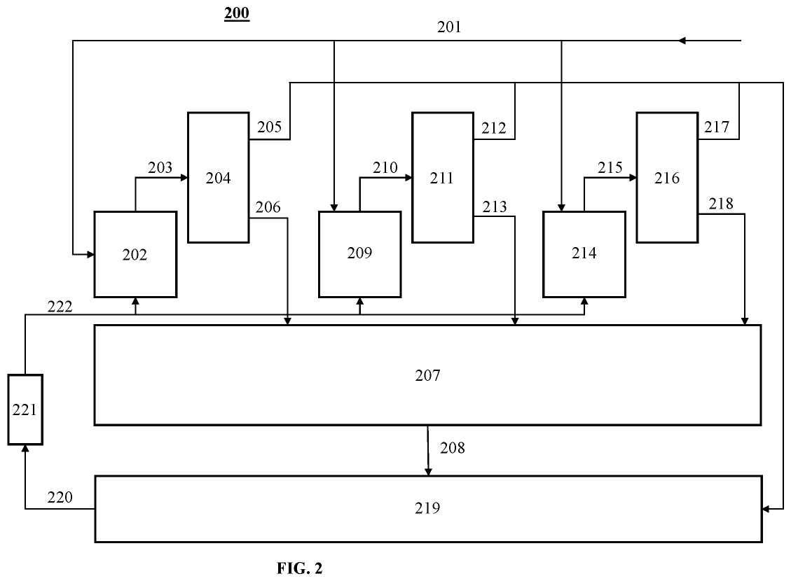

FIG. 2 is a flow diagram for a multi-pump and valve system 200 for lubricating a compressor cylinder using three pumps. New lubricating oil stream 201 is introduced into pump I 202, pump II 209, and pump III 214. The pumps may also receive (recycled) lubricating oil from filtered stream 222. Lubricating oil collected in oil collection pan 219 can be recycled through recycle stream 220, and then flowed through a filter 221 to produce the filtered stream 222.

Pump I 202 feeds lubricant oil I stream 203 to valve I 204. During maintenance, valve I 204 directs lubricating oil through atmospheric release I stream 205. During normal operation, valve I 204 directs lubricating oil through compressor oil I stream 206 to a compressor cylinder 207. Likewise, pump II 209 feeds lubricant oil II stream 210 to valve II 211. During maintenance, valve II 211 directs lubricating oil through atmospheric release II stream 212. During normal operation, valve II 211 directs lubricating oil through compressor oil II stream 213 to the compressor cylinder 207. Similarly, pump III 214 feeds lubricant oil III stream 215 to valve III 216. During maintenance, valve III 216 directs lubricating oil through atmospheric release III stream 217. During normal operation, valve III 216 directs lubricating oil through compressor oil III stream 218 to the compressor cylinder 207.

The atmospheric release I stream 205, the atmospheric release II stream 212, and the atmospheric release III stream 217 can direct lubricating oil to individual oil pans (not shown) or the collective oil collection pan 219. Used oil 208 from the compressor cylinder 207 also can be fed to the oil collection pan 219, if desired. When pump I 202 is removed from service, pump II 209, pump III 214, and the compressor cylinder 207 remain operational. The system can remain operational when any one of the three pumps is removed from service. Thus, the compressor cylinder 207 and compressor (not shown) do not need to incur a shutdown in order for maintenance to be performed on a single pump.

### Maintenance and Lubrication Methods

Maintenance and lubrication methods consistent with aspects of this disclosure can comprise (or consist essentially of, or consist of) I) circulating a first lubricating oil from a first pump through a first three-way valve into a lubricating oil inlet of a compressor cylinder and optionally discharging the first lubricating oil from a lubricating oil outlet, wherein the first three-way valve has an inlet for receiving the first lubricating oil from the first pump, a first outlet for discharging the first lubricating oil to the lubricating oil inlet of the compressor cylinder, and a second outlet for discharging the first lubricating oil to a first oil collection pan, II) circulating lubricating oils from two or more additional pumps through respective three-way valves into respective lubricating oil inlets of the compressor cylinder and optionally discharging the lubricating oils from the lubricating oil outlet, wherein the three-way valves have respective inlets for receiving the lubricating oils from the two or more additional pumps, respective first outlets for discharging the lubricating oils to the respective lubricating oil inlets of the compressor cylinder, and respective second outlets for discharging the lubricating oils to respective oil collection pans, III) removing the first pump from service, IV) closing the first outlet of the first three-way valve and opening the second outlet, V) performing maintenance on the first pump, VI) restoring flow of the first lubricating oil from the first pump through the first three-way valve, and VII) opening the first outlet of the first three-way valve and closing the second outlet.

In general, the method of lubrication of a compressor cylinder system comprises circulating lubricating oil from three or more pumps through a three-way valve for each pump into a lubricating oil inlet of a compressor cylinder and optionally discharging the lubricating oil from a lubricating oil outlet on the compressor cylinder. The three-way valves have respective inlets for receiving the lubricating oils from the three or more pumps, respective first outlets for discharging the lubricating oils to respective lubricating oil inlets of the compressor cylinder, and respective second outlets for discharging the lubricating oils to respective oil collection pans. During normal operation, respective first outlets for the three-way valves remain open directing lubricating oil from the three or more pumps to the respective lubricating oil inlets of the compressor cylinder.

The maintenance and lubrication methods are applicable for use with equipment operating at any pressure, but beneficially, are well suited for high pressure operations. For example, steps I) and II) can be conducted at high pressure conditions ranging often from 20,000 to 60,000 psig. In one aspect of this disclosure, the lubrication system can supply a part (or all) of a compressor having two or more compressor cylinders, more often eight compressor cylinders. The lubrication system can be comprised of 3 to 48 pumps. For example, in a compressor comprising eight cylinders, the total number of pumps can be 24 pumps.

The method of providing maintenance to a pump, titled hereafter the first pump, involves reducing the flow rate of the lubricating oil from the first pump, typically during steps III) to V). In one aspect of this disclosure, the flow rate or pump stroke of the first pump is reduced to its minimum possible value. Effectively, the first pump is removed from service. The first outlet of the respective three-way valve for the first pump is closed and the second outlet is opened directing lubricating oil to an oil collection pan. Now, maintenance may be performed on the first pump. Maintenance can include replacement and repair and can be performed over any suitable time period, such as from 10 min to 10 hr or more, or from 15 min to 6 hr, or from 20 min to 4 hr. While maintenance is occurring, the compressor cylinder (and the compressor) can maintain operation. There are no interruptions to standard production and no need for shutdown of the compressor and/or reactor. Once maintenance is completed, flow is restored from the first pump, the first outlet of the three-way valve is opened, the second outlet is closed, and normal operation proceeds.

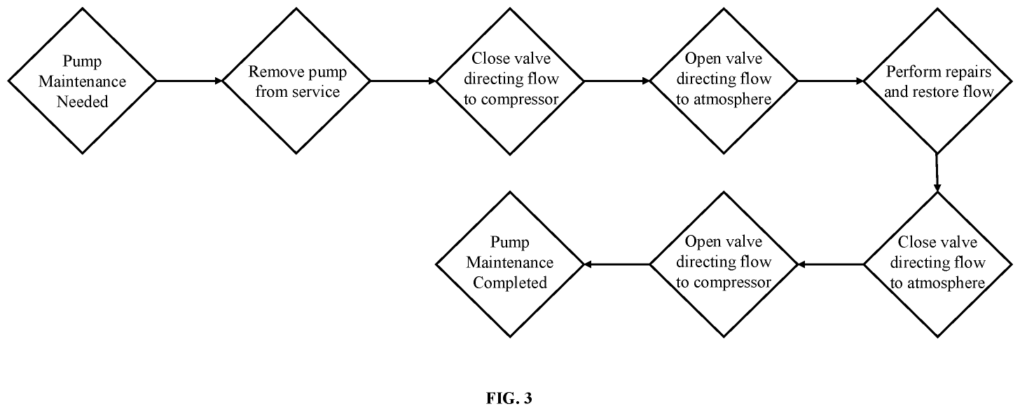

FIG. 3 illustrates the steps for performing maintenance on a pump in a lubrication system comprising a compressor cylinder, three or more pumps, respective three-way valves, and an oil collection pan. The steps are as follows: First, a pump in the system needs maintenance. Second, the pump is removed from service, and this can be to reduce the output rate of the pump, or the pump can be completely shut down. Next, the outlet of the three-way valve directing lubricating oil to the compressor cylinder is closed and the outlet of the three-way valve directing lubricating oil to the atmosphere (e.g., the oil collection pan) is opened. Then, pump repair or pump replacement is performed, and flow of lubricating oil is restored. Lastly, the outlet of the three-way valve directing lubricating oil to the atmosphere is closed and the outlet of the three-way valve directing lubricating oil to the compressor is opened. Maintenance is completed and normal operation continues.

### Example

The disclosure is further illustrated by the following example, which is not to be constructed in any way as imposing limitations to the scope of this disclosure. Various other aspects, modifications, and equivalents thereof which, after reading the description herein, can suggest themselves to one of ordinary skill in the art without departing from the spirit of the present disclosure or the scope of the appended claims.

A compressor is required to produce high pressure ethylene for a LDPE polymerization reactor. The system operated in a pressure range from 20,000-60,000 psig. The compressor had 8 compressor cylinders. Each of the compressor cylinders was supplied lubricating oil from three pumps, thus 24 pumps in total. The lubrication system was designed to prevent unnecessary downtime in production by employing three-way valves downstream of each pump. Each pump supplied lubricating oil to respective three-way valves and through a first outlet of each three-way valve to the compressor cylinder during normal operation. The compressor cylinder in this example consumed the lubricating oil, therefore there was no lubricating oil outlet.

Maintenance was required on one of the three pumps for one of the compressor cylinders. The pump needing maintenance was operated at a minimum pump stroke and removed from service. The other two pumps remained operating, and the compressor cylinder, compressor, and LDPE reactor remained in operation. For the three-way valve downstream of the pump needing maintenance, the second outlet was opened, directing lubricating oil to an oil collection pan, and the first outlet, directing lubricating oil to the compressor cylinder was closed. The pump was repaired, and flow of lubricating oil from the repaired pump was re-established. The second outlet of the three-way was closed and the first outlet was opened.

Prior to the methodology described above, when a pump required maintenance, the reactor was shut down and ethylene gas was removed from the compressor to allow the pump repairs to commence. Downtime was often 4-8 hr each time a pump required maintenance or replacement. The systems and methods provided herein represent a significant improvement, since maintenance and repairs can be accomplished with no downtime.

The disclosure is described above with reference to numerous aspects and specific examples. Many variations will suggest themselves to those skilled in the art in light of the above detailed description. All such obvious variations are within the full intended scope of the appended claims. Other aspects of the disclosure can include, but are not limited to, the following (aspects are described as “comprising”, but alternatively can “consist essentially of” or “consist of”):

Aspect 1. A system comprising:
i) a compressor cylinder having a lubricating oil inlet and an optional lubricating oil outlet;
ii) three or more pumps for circulating a lubricating oil to the lubricating oil inlet of the compressor cylinder;
iii) a three-way valve downstream of each pump, each valve having an inlet through which the lubricating oil is introduced, a first outlet configured to introduce the lubricating oil to the lubricating oil inlet of the compressor cylinder, and a second outlet configured to discharge the lubricating oil; and
iv) an oil collection pan configured to capture the lubricating oil from the second outlet of the three-way valve, and optionally from the lubricating oil outlet of the compressor cylinder.

Aspect 2. The system defined in aspect 1, wherein the compressor cylinder consumes the lubricating oil and does not have a lubricating oil outlet.

Aspect 3. The system defined in aspect 1, wherein the compressor cylinder has a lubricating oil outlet directing the lubricating oil from the compressor cylinder to the oil collection pan.

Aspect 4. The system defined in any one of aspects 1-3, wherein the system further comprises a compressor having two or more compressor cylinders.

Aspect 5. The system defined in aspect 4, wherein the compressor comprises eight compressor cylinders.

Aspect 6. The system defined in aspect 4 or 5, wherein the compressor is configured to deliver high pressure ethylene to a polymerization reactor, e.g., a tubular LDPE or autoclave LDPE reactor.

Aspect 7. The system defined in any one of aspects 1-6, wherein the three-way valve is configured to operate under high pressure conditions, e.g., from 20,000 to 60,000 psig.

Aspect 8. The system defined in any one of aspects 1-7, wherein the system is configured to operate under high pressure conditions, e.g., from 20,000 to 60,000 psig.

Aspect 9. The system defined in any one of aspects 1-8, wherein the system is configured to operate for a brief period of time (e.g., from 10 min to 10 hr) without one pump of the three or more pumps, e.g., two pumps are operating while one pump is undergoing maintenance.

Aspect 10. The system defined in any one of aspects 1-9, wherein the system further comprises a filtration unit upstream of the three or more pumps, the filtration unit configured to remove impurities from the lubricating oil.

Aspect 11. The system defined in aspect 10, wherein the filtration unit is further configured to filter the lubricating oil from the oil collection pan prior to recycling into the three or more pumps.

Aspect 12. The system defined in any one of aspects 1-11, wherein the system further comprises flow valves (e.g., ball valves, butterfly valves, check valves, globe valves, gate valves, etc.) on each lubricating oil stream upstream of the three or more pumps, the flow valves configured for controlling flow of the lubricating oil to each pump.

Aspect 13. The system defined in any one of aspects 1-12, wherein the system further comprises one or more monitoring devices for lubricating oil flow rate, lubricating oil pressure, lubricating oil temperature, or any combination thereof.

Aspect 14. The system defined in aspect 13, wherein the system further comprises a controller configured to adjust the lubricating oil flow rate, volume per stroke, pump power, or any combination thereof.

Aspect 15. The system defined in any one of aspects 1-14, wherein the system further comprises an injection device (e.g., an injection quill) at the lubricating oil inlet of the compressor cylinder.

Aspect 16. The system defined in any one of aspects 1-15, wherein the system further comprises a valve controller configured to, for any of the three or more pumps, close the first outlet of the three-way valve and open the second outlet to remove a pump from service (e.g., no longer supplying oil to compressor), and to open the first outlet of the three-way valve and close the second outlet to restore operation of the pump.

Aspect 17. A maintenance and lubrication method comprising:
I) circulating a first lubricating oil from a first pump through a first three-way valve into a lubricating oil inlet of a compressor cylinder and optionally discharging the first lubricating oil from a lubricating oil outlet,
wherein the first three-way valve has an inlet for receiving the first lubricating oil from the first pump, a first outlet for discharging the first lubricating oil to the lubricating oil inlet of the compressor cylinder, and a second outlet for discharging the first lubricating oil to a first oil collection pan;
II) circulating lubricating oils from two or more additional pumps through respective three-way valves into respective lubricating oil inlets of the compressor cylinder and optionally discharging the lubricating oils from the lubricating oil outlet,
wherein the three-way valves have respective inlets for receiving the lubricating oils from the two or more additional pumps, respective first outlets for discharging the lubricating oils to the respective lubricating oil inlets of the compressor cylinder, and respective second outlets for discharging the lubricating oils to respective oil collection pans;
III) removing the first pump from service;
IV) closing the first outlet of the first three-way valve and opening the second outlet;
V) performing maintenance on the first pump;
VI) restoring flow of the first lubricating oil from the first pump through the first three-way valve; and
VII) opening the first outlet of the first three-way valve and closing the second outlet.

Aspect 18. The method defined in aspect 17, wherein the compressor cylinder is part of a compressor having two or more compressor cylinders, e.g., eight compressor cylinders.

Aspect 19. The method defined in aspect 17 or 18, wherein the two or more additional pumps comprises any suitable number of pumps, e.g., from 2 to 48 pumps, or 2 pumps.

Aspect 20. The method defined in any one of aspects 17-19, wherein steps I) and II) are conducted at high pressure, e.g., from 20,000 to 60,000 psig.

Aspect 21. The method defined in any one of aspects 17-20, wherein a flow rate of the first lubricating oil from the first pump is reduced during steps III) to V).

Aspect 22. The method defined in any one of aspects 17-21, wherein the compressor cylinder or the compressor maintains operation throughout the method.

Aspect 23. The method defined in any one of aspects 17-22, wherein step V) is conducted over any suitable period of time, e.g., from 10 min to 10 hr, from 15 min to 6 hr, or from 20 min to 4 hr.

We claim:

1. A system comprising:
i) a compressor cylinder having a lubricating oil inlet and an optional lubricating oil outlet;
ii) three or more pumps for circulating a lubricating oil to the lubricating oil inlet of the compressor cylinder;
iii) a three-way valve downstream of each pump, each valve having an inlet through which the lubricating oil is introduced, a first outlet configured to introduce the lubricating oil to the lubricating oil inlet of the compressor cylinder, and a second outlet configured to discharge lubricating oil; and
iv) an oil collection pan configured to capture lubricating oil from the second outlet of the three-way valve, and optionally from the lubricating oil outlet of the compressor cylinder.

2. The system of claim 1, wherein the system further comprises a compressor having two or more compressor cylinders.

3. The system of claim 2, wherein the compressor is configured to deliver high pressure ethylene to a polymerization reactor.

4. The system of claim 1, wherein the three-way valve is configured to operate under high pressure conditions from 20,000 to 60,000 psig.

5. The system of claim 1, wherein the system is configured to operate under high pressure conditions from 20,000 to 60,000 psig.

6. The system of claim 1, wherein the system is configured to operate without one of the three or more pumps for 10 min to 10 hr.

7. The system of claim 1, wherein the system further comprises flow valves on each lubricating stream upstream of the three or more pumps, allowing for controlled flow of the lubricating oil to each pump.

8. The system of claim 1, wherein the system further comprises a monitoring device for lubricating oil flow rate, lubricating oil pressure, lubricating oil temperature, or any combination thereof.

9. The system of claim 8, wherein the system further comprises a controller configured to adjust the lubricating oil flow rate, volume per stroke, pump power, or any combination thereof, based on measurements from the monitoring device.

10. The system of claim 1, wherein the system further comprises an injection device at the lubricating oil inlet of the compressor cylinder.

11. The system of claim 1, wherein the system further comprises a valve controller configured to, for any of the three or more pumps, close the first outlet of the three-way valve and open the second outlet to remove a pump from service, and to open the first outlet of the three-way valve and close the second outlet to restore operation of the pump.

12. The system of claim 1, wherein the system further comprises a recycle stream directing used lubricating oil from the oil collection pan to a filtration unit upstream of the pumps.

13. A maintenance and lubrication method comprising:
I) circulating a first lubricating oil from a first pump through a first three-way valve into a lubricating oil inlet of a compressor cylinder and optionally discharging the first lubricating oil from a lubricating oil outlet,
wherein the first three-way valve has an inlet for receiving the first lubricating oil from the first pump, a first outlet for discharging the first lubricating oil to the lubricating oil inlet of the compressor cylinder, and a second outlet for discharging the first lubricating oil to a first oil collection pan;
II) circulating lubricating oils from two or more additional pumps through respective three-way valves into respective lubricating oil inlets of the compressor cylinder and optionally discharging the lubricating oils from the lubricating oil outlet,
wherein the three-way valves have respective inlets for receiving the lubricating oils from the two or more additional pumps, respective first outlets for discharging the lubricating oils to the respective lubricating oil inlets of the compressor cylinder, and respective second outlets for discharging the lubricating oils to respective oil collection pans;
III) removing the first pump from service;
IV) closing the first outlet of the first three-way valve and opening the second outlet;
V) performing maintenance on the first pump;
VI) restoring flow of the first lubricating oil from the first pump through the first three-way valve; and
VII) opening the first outlet of the first three-way valve and closing the second outlet.

14. The method of claim 13, wherein the compressor cylinder is a part of a compressor having two or more compressor cylinders.

15. The method of claim 13, wherein the two or more additional pumps comprise from 2 to 48 pumps.

16. The method of claim 13, wherein steps I) and II) are conducted at a high pressure from 20,000 to 60,000 psig.

17. The method of claim 13, wherein in step III), a flow rate of the first lubricating oil from the first pump is reduced.

18. The method of claim 13, wherein in step III), the first pump is shut down.

19. The method of claim 13, wherein the compressor cylinder maintains operation throughout the method.

20. The method of claim 13, wherein step V) is conducted over a period of time from 10 min to 10 hr.
